(19) United States
(12) Patent Application Publication
(10) Pub. No.: US 2014/0118780 A1
(43) Pub. Date: May 1, 2014

(54) PRINT DOCUMENT MANAGEMENT APPARATUS, PRINT DOCUMENT MANAGEMENT SYSTEM, PRINT DOCUMENT MANAGEMENT METHOD, AND COMPUTER PROGRAM

(71) Applicant: Canon Kabushiki Kaisha, Tokyo (JP)

(72) Inventor: Mitsuo Kimura, Kawasaki-shi (JP)

(73) Assignee: Canon Kabushiki Kaisha, Tokyo (JP)

(21) Appl. No.: 14/057,426

(22) Filed: Oct. 18, 2013

(30) Foreign Application Priority Data
Oct. 26, 2012 (JP) 2012-236803

(51) Int. Cl. G06F 3/12

(52) U.S. Cl. CPC G06F 3/1293
USPC 358/1.15

(57) ABSTRACT

A print document management system adds individual transfer document information to a transfer document list, which can be accessed by a plurality of users, if it is determined that a transfer destination user is specified in a request for uploading print document data, wherein the individual transfer document information includes information for identifying the print document data, information about a transfer source user, and information about the transfer destination user. When the transfer destination user makes a request for acquiring a print document list, the system searches the transfer document list for individual transfer document information and adds print document data identified based on the searched-for individual transfer document information to a print document list of the transfer destination user.

### BACKGROUND

1. Field of the Disclosure

Aspects of the present invention generally relate to a print document management system for independently managing a print document of each user by using a print document list for each user.

2. Description of the Related Art

Up until now, there has been known a print document management system which manages document data to be printed and a printer at a print destination. The print document management system receives document data from a user application or other document management systems, generates print document information, associates the print document information with the document data, and stores the print document information. The print document management system executes print processing according to a user's print execution request and reflects results of the print processing in the print document information.

Japanese Patent Application Laid-Open No. 2008-134811 discusses a technique whereby the right of printing a document managed by a server is transferred from a first terminal to a second terminal. In Japanese Patent Application Laid-Open No. 2008-134811, when the first terminal sends a request for transferring the print right to a server, the server issues a printing password and transmits a print right transfer notification including the printing password to the second terminal as a transfer destination. The second terminal generates print right data based on the received print right transfer notification and can print the document managed by the server by using the print right data. More specifically, any document managed by the server can be accessed by all terminals and can be printed as long as a terminal has print right data.

In recent years, on the other hand, as the Internet diffuses and network speed becomes faster, functions which have been provided by software are more frequently provided as a service on the Internet. The print document management system may exist as a backend of such a service. A service on the Internet is provided for a plurality of tenants (e.g., contracting entities such as contracting companies). If the service is provided for a plurality of tenants, a user management of each tenant is performed by an authentication service provided on the Internet.

In a case where a printing service is provided on the Internet, a print document needs to be associated with user information managed by an authentication service and to be individually managed for each user. Especially, a printing service for the general public on the Internet needs to be strengthened in terms of security. For this reason, a list for managing a print document of each user is completely independent for each user and access-controlled so that other users cannot refer to the list.

On the other hand, there is a use case where a print document itself is desired to be transferred to another user in a system with such strict security where a list of print documents is completely independent for each user and the access right thereof is managed. In other words, there is a use case where the owner of a print document is desired to be changed from a transfer source user to a transfer destination user. However, in a printing service having a system with such strict security at the backend thereof, it is not easy to realize the transfer of a print document between users. For example, a user A cannot directly access the print document list of a user B, so that the user A cannot directly transfer a print document to the print document list of the user B. Furthermore, the user B cannot directly access the print document list of the user A, so that the user B cannot directly acquire a print document from the print document list of the user A.

### SUMMARY

Aspects of the present invention relate to a technique for transferring a print document between users (for changing an owner of a print document) in a printing service on the Internet where a list of print documents is independently provided for each user and the right to access the list of print documents is managed.

According to an aspect of the present invention, a print document management apparatus for managing a print document list for each user includes a transfer document determination unit configured to determine whether a request for uploading print document data specifies a transfer destination user to whom the print document data is to be transferred, a first addition unit configured to add individual transfer document information, including information for identifying the print document data, information about a transfer source user, and information about the transfer destination user, to a transfer document list, which can be accessed by a plurality of users, if the transfer document determination unit determines that the transfer destination user is specified, a second addition unit configured to search, when a request for acquiring the print document list is received, the transfer document list for the individual transfer document information in which a user who makes the request for acquiring the print document list is specified as the transfer destination user, and to add print document data identified based on the searched-for individual transfer document information to a print document list of the user who makes the request for acquiring the print document list, and a transmission unit configured to transmit the print document list of the user who makes the request for acquiring the print document list.

Further features of the present disclosure will become apparent from the following detailed description of exemplary embodiments with reference to the attached drawings.

### BRIEF DESCRIPTION OF THE DRAWINGS

FIG. 1 is a block diagram illustrating a general configuration of a print document management system.

FIG. 2 is a block diagram illustrating a hardware configuration of a client terminal and a server.

FIG. 3 is a block diagram illustrating a hardware configuration of a printer.

FIGS. 4A and 4B are block diagrams illustrating an authentication server and a request reception server respectively.

FIGS. 5A and 5B are block diagrams illustrating a print document management server and a print server.

FIG. 6 is a block diagram of a print document data storage server.

FIG. 7 is a chart illustrating user information.

FIG. 8 is a chart illustrating print document information.

FIG. 9 illustrates a flow of processing in receiving a request for uploading print document data.

FIG. 10 illustrates a flow of processing in receiving a request for acquiring a print document list.

FIG. 11 illustrates a flow of processing in a case where a print request is received to perform a printing process.

FIG. 12 is a flow chart illustrating the flow of processing in receiving a request for uploading print document data.

FIG. 13 is a flow chart illustrating the flow of processing in receiving a request for acquiring a print document list.

### DESCRIPTION OF THE EMBODIMENTS

The print document management system on which the present exemplary embodiment is premised is described below.

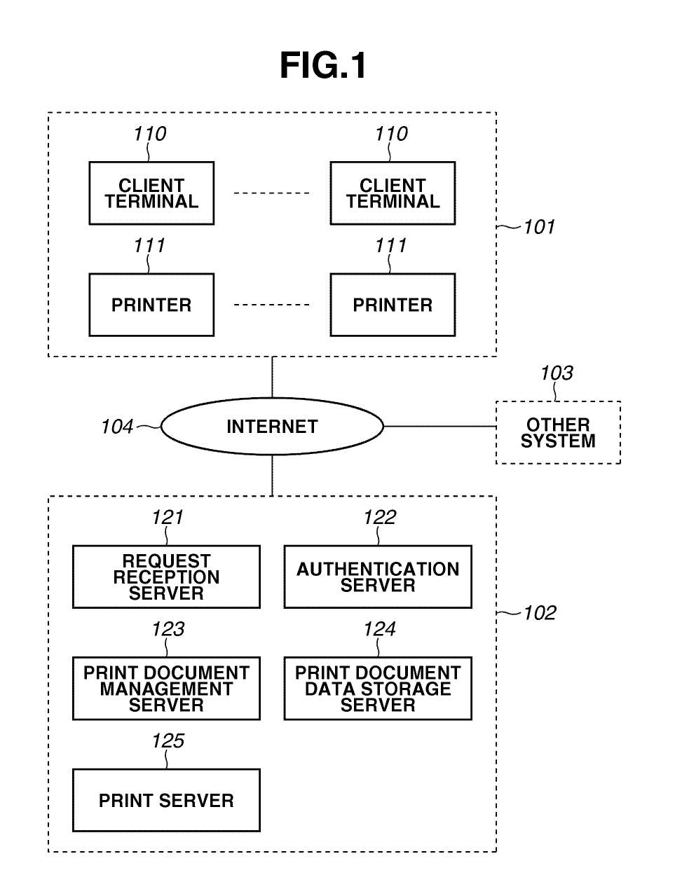

FIG. 1 illustrates a general configuration of the print document management system according to the present exemplary embodiment. FIG. 1 includes a system 101 which is in an intranet in companies and others. A client terminal 110 and a printer 111 are connected to each other via a communication line (not illustrated). FIG. 1 presumes that a plurality of the client terminals 110 and the printers 111 are connected.

A print document management system 102 is provided in a data center. A request reception server 121, an authentication server 122, a print document data storage server 124, a print document management server 123, and a print server 125 are connected to one another via a communication line (not illustrated).

The communication line is a communication network realized, for example, by any of a local area network (LAN), a wide area network (WAN), a telephone line, a dedicated digital line, an asynchronous transfer mode (ATM) or a frame relay line, a cable television line, and a wireless line for data broadcasting, or by a combination of the above lines. The communication line has only to enable data to be transmitted and received. A communication means between the client terminal 110 and the printer 111 and between the servers may be different.

Other system 103 is also provided in a data center. The other system 103 and the print document management system 102 may be in the same or different data centers. It is assumed that the other system 103 is a service to input a print document into the print document management system 102 based on instructions from the client terminal 110.

The system 101, the print document management system 102, and the other system 103 are connected to one another via the Internet 104.

The client terminal 110 may be, for example, a desktop personal computer, a note personal computer, a mobile personal computer, a personal digital assistant (PDA), or a cellular phone incorporating the execution environment of a program (such as a smart phone).

The printer 111 is a device, such as a laser printer or a multifunction peripheral (MFP), which can be connected to a network and has a printing function.

The request reception server 121 receives a request from the client terminal 110 or the printer 111 and sends back a response.

The authentication server 122 supports an authentication protocol such as open identification (ID) and manages information about a user who accesses the printing system. The authentication server 122 receives a request from the client terminal 110 to authenticate a user and issues an access token. The authentication server 122 also receives an inquiry from the request reception server 121 and verifies the validity of the access token.

The print document data storage server 124 is a file server which supports a file sharing protocol such as a server message block (SMB), or is a storage such as a storage area network (SAN) and a network attached storage (NAS), which can be directly connected to a network. The print document data storage server 124 stores print document data associated with print document information.

The print document management server 123 manages print document information which is associated with the print document data stored in the print document data storage server 124.

The print server 125 receives a print request, reads out the print document data stored in the print document data storage server 124, and converts the print document data into a format which can be interpreted by the printer 111.

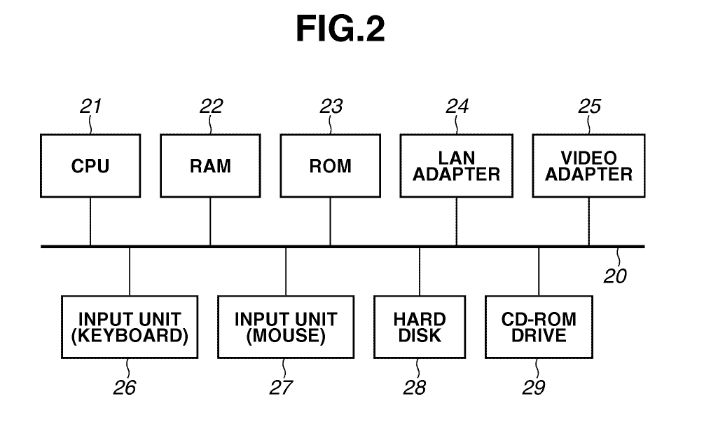

FIG. 2 is a block diagram illustrating a basic hardware configuration of the client terminal 110, the request reception server 121, the authentication server 122, the print document data storage server 124, the print document management server 123, and the print server 125.

In FIG. 2, a central processing unit (CPU) 21, a random access memory (RAM) 22, a read only memory (ROM) 23, a local area network (LAN) adapter 24, a video adapter 25, an input unit (a keyboard) 26, an input unit (a mouse) 27, a hard disk 28, and a compact disk (CD)-ROM drive 29 are connected to one another via a system bus 20. The system bus 20 is formed of a peripheral component interconnect (PCI) bus, an accelerated graphics port (AGP) bus, and a memory bus, for example. In FIG. 2, the illustration of a chip for connecting the buses, a keyboard interface, and an input/output interface such as a small computer system interface (SCSI) or an attachment packet interface (ATAPI) is omitted.

The CPU 21 performs various calculations such as four arithmetic operations and a comparison operation based on the program of an operation system and an application program, and controls the hardware. The RAM 22 is used to execute the program of an OS or an application program, which is read from a storage medium such as the hard disk 28 or the CD ROM attached to the CD-ROM drive 29. These programs are executed by the CPU 21.

The ROM 23 stores a basic input/output system (BIOS) for controlling input and output of data to and from the hard disk 28 in collaboration with an operation system. The LAN adapter 24 communicates with an external apparatus connected via a network in collaboration with the communication program of the operation system controlled by the CPU 21. The video adapter 25 generates an image signal to be output to a display device. The keyboard 26 and the mouse 27 are a user interface for inputting instructions from the user.

The hard disk 28 stores an operating system and an application program (such as a printing system program according to the exemplary embodiment of the present invention).

The CD-ROM drive 29, to which a storage medium such as a CD-ROM, a CD-recordable (CD-R), and a CD-rewritable (CD-R/W) is attached, is used to install an application program in the hard disk 28. It is to be understood that any other optical drive (such as a CD-R drive, a digital versatile disc (DVD) drive, and a Blu-ray Disk (BD) drive) may be used.

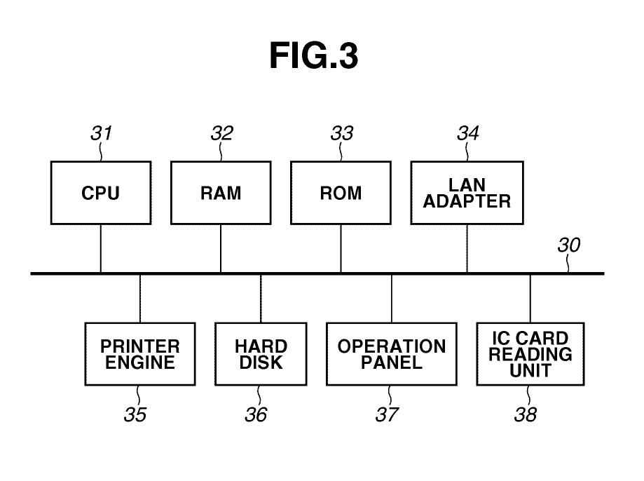

FIG. 3 is a block diagram illustrating a basic hardware configuration of the printer 111. In FIG. 3, a CPU 31, a RAM 32, a ROM 33, a LAN adapter 34, a printer engine 35, a hard disk 36, an operation panel 37 and an IC card reading unit 38 are connected to one another via a system bus 30. The system bus 30 is formed of a PCI bus, an AGP bus, and a memory bus, for example. In FIG. 3, the illustration of a chip for connecting the buses, a keyboard interface, and an input/output interface such as a small computer system interface (SCSI) or an attachment packet interface (ATAPI) is omitted.

The CPU 31 uses the RAM 32 as a work memory to execute the software stored in the hard disk 36. The CPU 31 sets the operation of the printer 111 according to user's instructions input from the operation panel 37. The CPU 31 generates image data based on the print data input from an external apparatus via the LAN adapter 34 and supplies the image data to the printer engine 35 to perform printing. The ROM 33 stores a BIOS for controlling input and output of data to and from the hard disk 36.

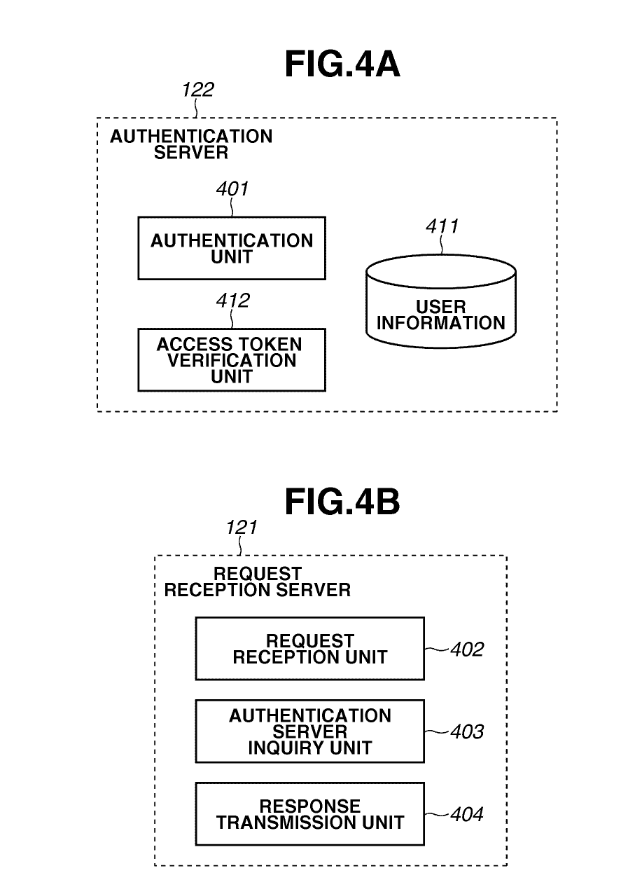

FIGS. 4A and 4B, FIGS. 5A and 5B, and FIG. 6 illustrate block diagrams of the servers configuring the system. In the present exemplary embodiment, the CPU of each server executes each program to function as each processing unit, however, a part of the processing unit may be realized by hardware such as an electronic circuit.

FIG. 4A is a block diagram of the authentication server 122. The authentication server 122 stores user information 411. The authentication server 122 includes an authentication unit 401 which receives a request for authenticating a user from the client terminal 101, authenticates the user according to the user information 411 and then issues an access token. The authentication server 122 includes an access token verification unit 412 which receives the access token and verifies the validity thereof.

FIG. 4B is a block diagram of the request reception server 121. The request reception server 121 includes a request reception unit 402 which receives a request from the client terminal 101, an authentication server inquiry unit 403 which requests the authentication server 122 to verify an access token, and a response transmission unit 404 which transmits a response to the client terminal 101.

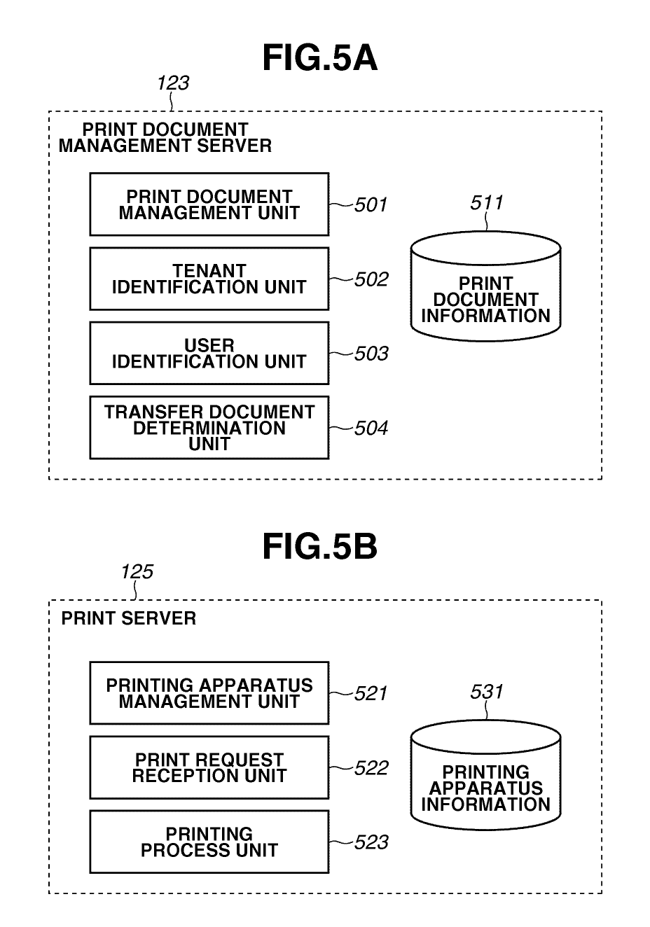

FIG. 5A is a block diagram of the print document management server 123. The print document management server 123 stores print document information 511 associated with the print document data stored in the print document data storage server 124. The print document management server 123 includes a print document management unit 501 which manages the print document information 511, a tenant identification unit 502 which identifies the tenant to which a user belongs, based on the user information acquired from the authentication server 122, and a user identification unit 503 which identifies the user. The print document management server 123 also includes a transfer document determination unit 504 which determines whether an uploaded print document is an object to be transferred.

FIG. 5B is a block diagram of the print server 125. The print server 125 stores printing apparatus information 531 which manages the printer 102. The print server 125 includes a printing apparatus management unit 521 which manages the printing apparatus information 531, and a print request reception unit 522 which receives a print request from the print document management server 123. The print server 125 also includes a printing process unit 523 which reads out the print document data stored in the print document data storage server 124 and then converts the print document data into a format which can be interpreted by the printer 111.

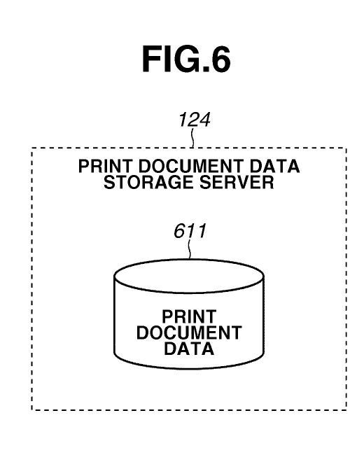

FIG. 6 is a block diagram of the print document data storage server 124. The print document data storage server 124 stores print document data 611.

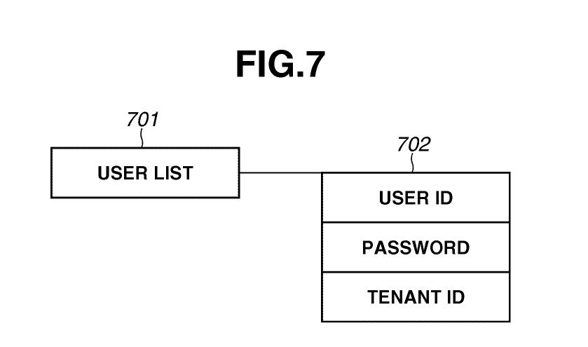

FIG. 7 is a chart illustrating in detail the user information 411 stored in the authentication server 122. The user information 411 includes a user list 701. The user list 701 is a list of individual user information 702 including a user ID, a password, and a tenant ID of each user.

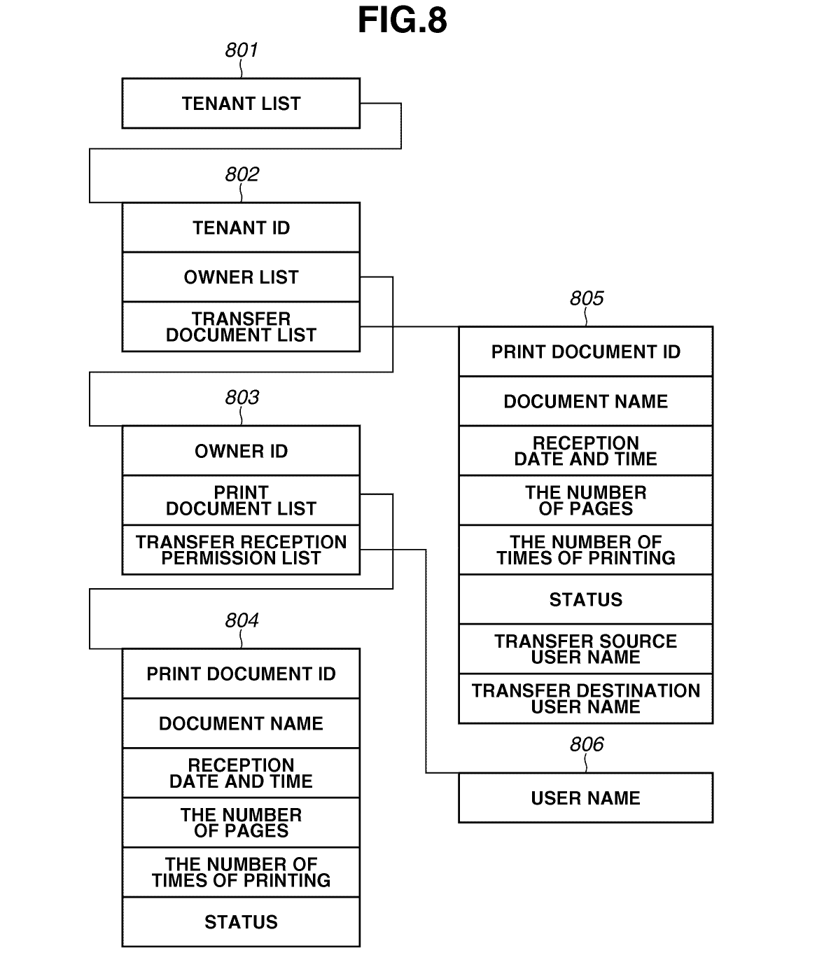

FIG. 8 is a chart illustrating in detail the print document information 511 stored in the print document management server 123. The print document information 511 includes a tenant list 801. The tenant list 801 includes individual tenant information 802 including a tenant ID, an owner list (a user who uploads a print document is called the owner of the print document), and a transfer document list of each tenant. The owner list includes individual owner information 803 including an owner ID (the ID of a user who uploads a print document), a print document list, and a transfer reception permission list of each owner. The print document list includes individual print document information 804 including a print document ID, a document name, reception date and time, the number of pages, the number of times of printing, and status of each print document. The transfer document list in the individual tenant information 802 includes individual transfer document information 805 including a print document ID, a document name, reception date and time, the number of pages, the number of times of printing, status, a transfer source user name, and a transfer destination user name of each transfer document. The transfer reception permission list in the individual owner information 803 includes individual transfer reception permission information 806 including the name of a user who is permitted for transfer.

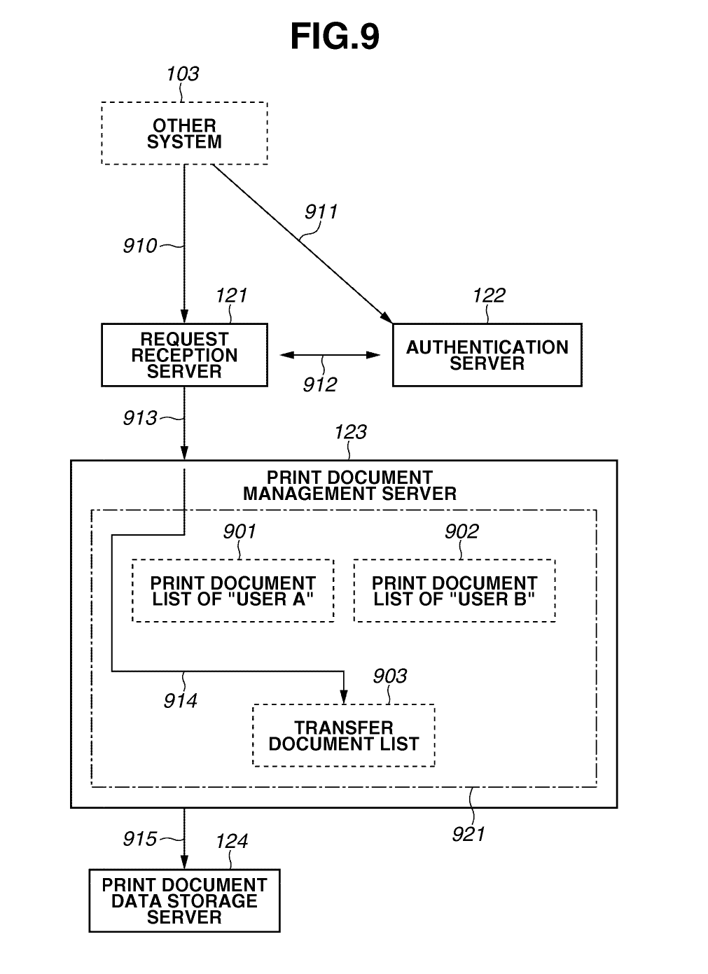

FIGS. 9 to 11 illustrate flow charts of the print document management system according to the present exemplary embodiment.

FIG. 9 illustrates a flow of processing in a case where the print document management system according to the present exemplary embodiment receives a request for uploading print document data (e.g., a PDF document of a form) from the other system 103 (e.g., a form generation service). The other system 103, for example, generates a form document based on instructions for generating a form from the user of the client terminal 110 (a user A, for example) and starts a process to transmit a request for uploading the generated document as print document data to the print document management system. It is premised that the other system 103 collaborates in user authentication with the print document management system 102.

The other system 103 transmits a user name (the name of a user who requests a form service is assumed to be “user A”, for example.) and a password to the authentication server 122 for authentication and acquires the access token required for accessing the print document management system (911). The access token is associated with the user information managed by the authentication server 122. Then, the other system 103 transmits a request for uploading the print document data to the request reception server 121 (910). The upload request includes the print document data, information associated therewith, and the access token acquired from the authentication server 122.

The request reception server 121 receiving the upload request inquires of the authentication server 122 whether the access token included in the upload request is valid (912). The authentication server 122 verifies the validity of the access token. If the access token is valid, the authentication server 122 transmits the user information associated with the access token to the request reception server 121 (912). For example, information of the user A associated with the access token is transmitted thereto. If the access token is not valid, an error response is transmitted thereto. When the request reception server 121 receives the user information associated with the access token from the authentication server 122, the request reception server 121 transmits the upload request and the received user information to the print document management server 123 (913).

The print document management server 123 determines whether a transfer destination user is specified in the upload request. If the transfer destination user is not specified, the uploaded print document is added to a print document list of the “user A” 901. The print document list 901 exists for each user and is access-controlled by the print document management server 123 so that the print document list 901 cannot be accessed unless the corresponding user information exists. More specifically, user information about the user A is required to access the print document list of the “user A” 901, and in order to acquire the user information, the access token associated with the user information needs to be acquired from the authentication server. The same holds true for the user B.

Herein, the “user B” is presumed to be specified as the transfer destination user. Because the print document list of the “user B” 902 cannot be accessed using the user information about the user A, the print document is added to the transfer document list 903 included in the individual tenant information 802 in FIG. 8 (914). The transfer document list 903 is access-controlled by the print document management server 123 so that the transfer document list 903 can be accessed by all users in the tenant. It is assumed that the users A and B belong to the same tenant (921) and the transfer document list 903 exists for each tenant. The individual transfer document information 805 registered in the transfer document list 903 includes the print document ID of the print document data which is requested to be uploaded, the name of a transfer source user (the user A who makes the upload request), and the name of a transfer destination user (the user B).

The print document management server 123 stores the print document data which is requested to be uploaded in the print document data storage server 124 (915).

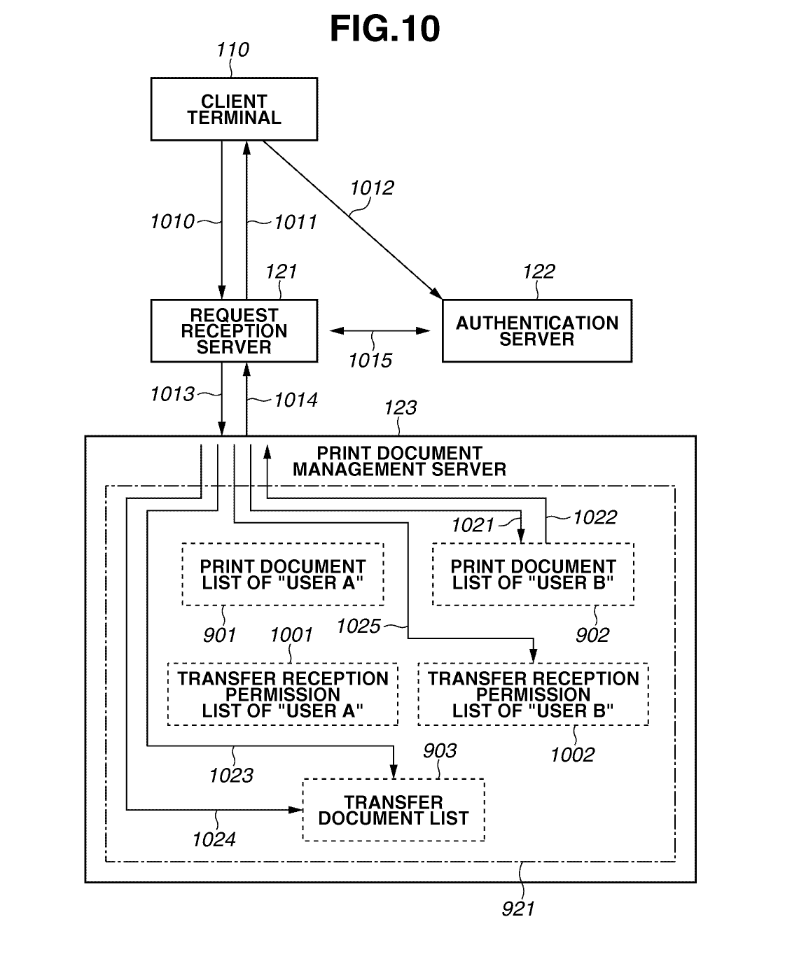

FIG. 10 illustrates a flow of processing in a case where the print document management system according to the present exemplary embodiment receives a request for acquiring a print document list transmitted from the client terminal 110.

The client terminal 110 transmits a user name (“user B”, for example) and a password to the authentication server 122 for authentication and acquires the access token required for accessing the print document management system 102 (1012). The client terminal 110 transmits a print document list acquisition request to the request reception server 121 (1010). The print document list acquisition request includes the access token acquired from the authentication server 122 (the access token of the user B).

The request reception server 121 receiving the print document list acquisition request from the client terminal 110 inquires of the authentication server 122 whether the access token included in the print document list acquisition request is valid (1015). The authentication server 122 verifies the validity of the access token. If the access token is valid, the authentication server 122 transmits the user information associated with the access token to the request reception server 121 (1015). For example, information of the user A associated with the access token is transmitted thereto. When the request reception server 121 receives the user information associated with the access token from the authentication server 122, the request reception server 121 transmits the print document list acquisition request and the received user information to the print document management server 123 (1013).

The print document management server 123 searches the transfer document list 903 included in the individual tenant information 802 in FIG. 8 to check if there is individual transfer document information in which the “user B” is specified as the transfer destination (1023). If there is a document specified to be transferred to the “user B,” the print document management server 123 checks if the “user A” being the transfer source user of the transfer document is included in the transfer reception permission list 1002 of the “user B” (included in the individual owner information 803 in FIG. 8) (1025). If the print document management server 123 confirms that the “user A” is included in the transfer reception permission list of the “user B” 1002, the print document management server 123 adds the print document information of the transfer document to the print document list of the “user B” 902 (1021) and deletes the individual transfer document information from the transfer document list 903 (1024). If the print document management server 123 confirms that the “user A” being the transfer source user is not included in the transfer reception permission list of the “user B” 1002, the print document management server 123 does not add the transfer document to the print document list of the “user B” 902. Using the transfer reception permission list 1002 enables the user permitted as the transfer source to be previously specified, thereby allowing the transfer of a document from an unidentified user to be automatically denied.

After the print document management server 123 finishes checking of the transfer documents stored in the transfer document list, the print document management server 123 obtains the print document list of the “user B” 902 (1022) and transmits data of the obtained print document list to the request reception server 121 (1014). The request reception server 121 transmits the received print document list to the client terminal 110 as a response to the print document list acquisition request (1011).

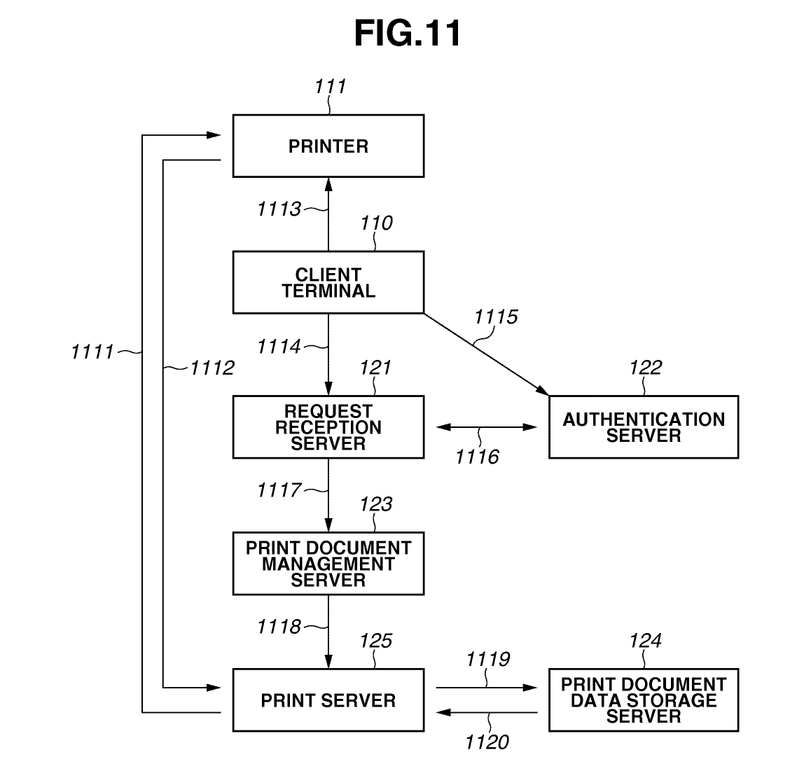

FIG. 11 illustrates a flow of processing in a case where the print document management system according to the present exemplary embodiment receives a print request transmitted from the client terminal 110. The client terminal 110 transmits a print request for executing a process to print the document selected by the user from the print document list transmitted in FIG. 10.

The client terminal 110 transmits a user name and a password to the authentication server 122 for authentication and acquires the access token required for accessing the print document management system 102 (1115). The client terminal 110 transmits a print request to the request reception server 121 and the printer 111 (1114 and 1113). The print request transmitted from the client terminal 110 to the request reception server 121 includes the print document ID of the document which the user specifies as an object to be printed, the printer name at the print destination, print attributes (such as the number of print copies and two-sided printing), and the access token acquired from the authentication server 122. The print request transmitted to the printer 111 includes the print document ID.

The request reception server 121 receiving a print request from the client terminal 110 inquires of the authentication server 122 whether the access token in the print request is valid (1116). The authentication server 122 verifies the validity of the access token. If the access token is valid, the authentication server 122 transmits user information associated with the access token to the request reception server 121 (1116). When the request reception server 121 receives the user information associated with the access token from the authentication server 122, the request reception server 121 transmits the print request and the received user information to the print document management server 123 (1117).

The print document management server 123 transmits the print request and user information received from the request reception server 121 to the print server 125 (1118). The print server 125 requests the print document data storage server 124 to send the print document data associated with the print document ID included in the print request (1119) and acquires the print document data from the print document data storage server 124 (1120). The print server 125 converts the acquired print document data into print data which can be interpreted by the printer 111 specified as the print destination, and stores the print data. The printer 111 receiving the print request from the client terminal 110 transmits the print document ID included in the print request to the print server 125 (1112). The print server 125 transmits the print data corresponding to the print document ID received from the printer 111 to the printer 111 to cause the printer 111 to print (1111).

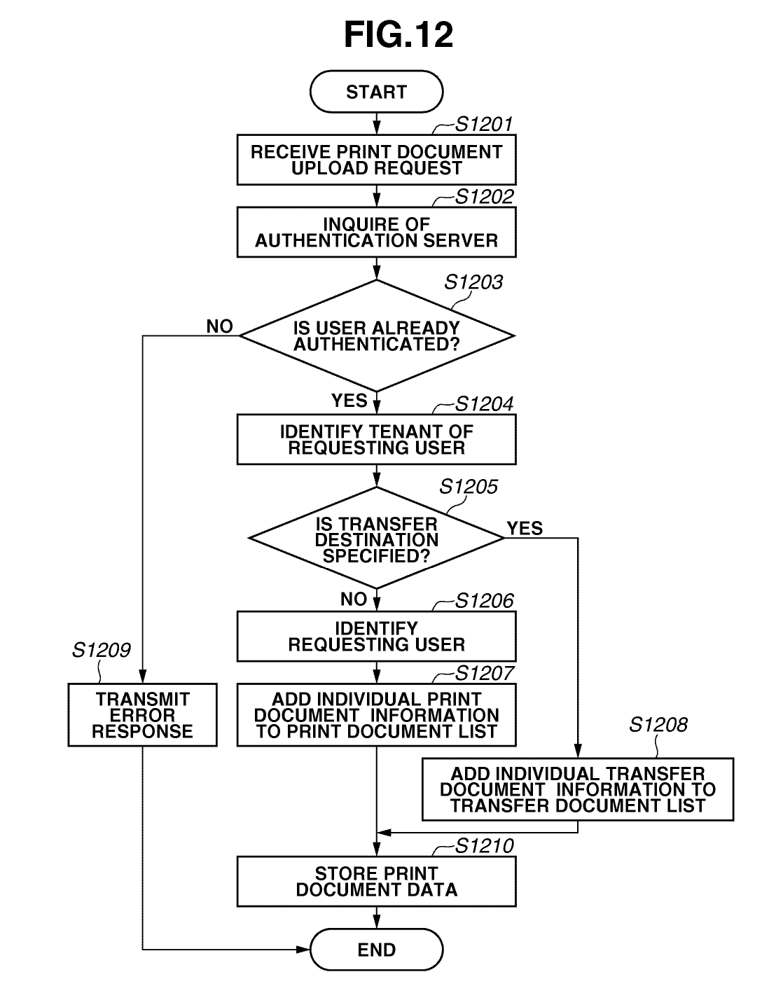

FIG. 12 is a flow chart illustrating the flow of processing performed by the request reception server 121 and the print document management server 123 in FIG. 9. In step S1201, the request reception unit 402 of the request reception server 121 receives a print document upload request from the other system. In step 1202, the authentication server inquiry unit 403 of the request reception server 121 inquires of the authentication server 122 whether the request is made by an authenticated user (whether the access token included in the request is valid).

As a result of inquiring of the authentication server 122, if the authentication server inquiry unit 403 determines that the request is made by an unauthenticated user (the access token included in the request is invalid) (NO in step S1203), the processing proceeds to step S1209. In step S1209, the response transmission unit 404 of the request reception server 121 transmits an error response as a response to the request to the other system and ends the processing. In step S1203, if the authentication server inquiry unit 403 determines that the request is made by an authenticated user (the access token included in the request is valid) (YES in step S1203), the request reception server 121 transmits the upload request and the authenticated user information to the print document management server 123.

In step S1204, the tenant identification unit 502 of the print document management server 123 searches the tenant list 801 in FIG. 8 by using the tenant ID included in the user information to identify the individual tenant information 802 of the user who makes the request.

In step 1205, the transfer document determination unit 504 of the print document management server 123 determines whether the upload request specifies the transfer destination user. If the transfer document determination unit 504 determines that the upload request specifies the transfer destination user (YES in step S1205), in step S1208, the transfer document determination unit 504 generates the individual transfer document information 805 in FIG. 8 and adds the generated individual transfer document information 805 to the transfer document list included in the individual tenant information 802. The processing proceeds to step S1210. If the transfer document determination unit 504 determines that the upload request does not specify the transfer destination user (NO in step S1205), in step S1206, the user identification unit 503 of the print document management server 123 searches the owner list included in the individual tenant information 802 to identify the individual owner information 803 of the user who makes the upload request. In step S1207, the print document management unit 501 of the print document management server 123 generates the individual print document information 804 in FIG. 8 based on the upload request and adds the generated individual print document information 804 to the print document list included in the individual owner information 803. The processing proceeds to step S1210. In step S1210, the print document management unit 501 of the print document management server 123 stores the print document data included in the request on the print document data storage server 124.

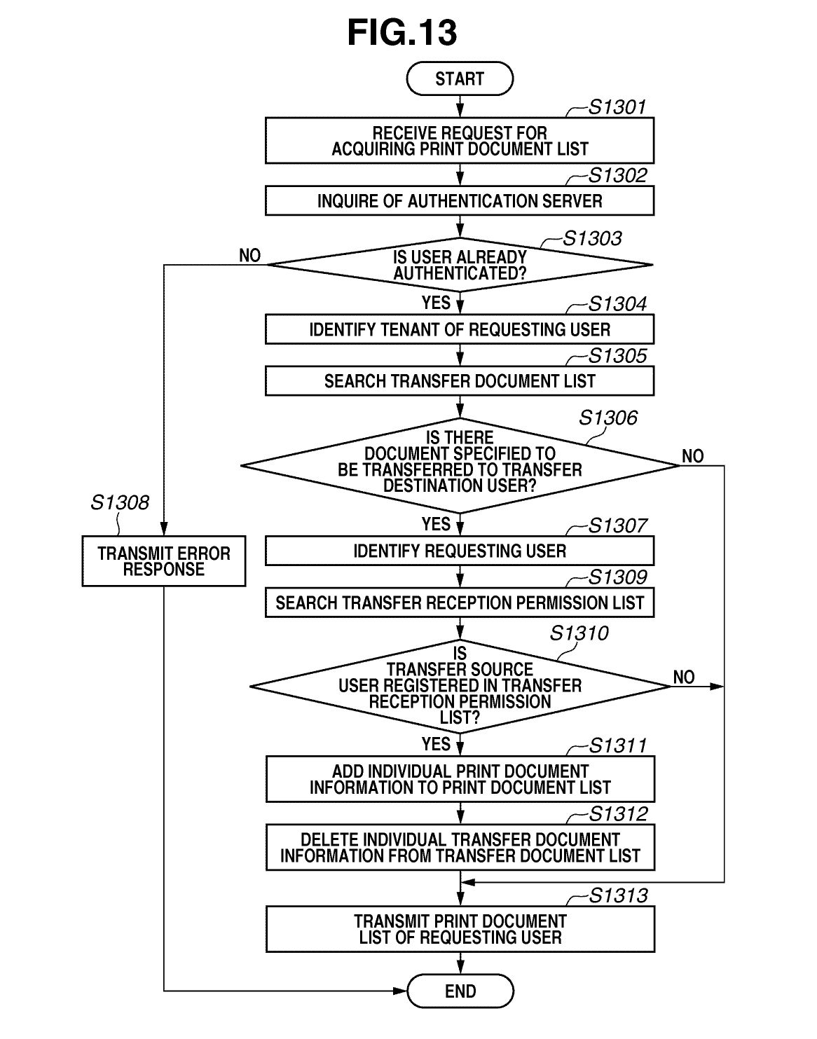

FIG. 13 is a flow chart illustrating the flow of processing performed by the request reception server 121 and the print document management server 123 in FIG. 10. In step S1301, the request reception unit 402 of the request reception server 121 receives a print document list acquisition request from the client terminal 110. In step S1302, the authentication server inquiry unit 403 of the request reception server 121 inquires of the authentication server 122 whether the request is made by an authenticated user (whether the access token included in the request is valid).

If the authentication server inquiry unit 403 determines that the request is made by an unauthenticated user (the access token included in the request is invalid) based on the result of inquiring of the authentication server 122 (NO in step S1303), the processing proceeds to step S1308. In step S1308, the response transmission unit 404 of the request reception server 121 transmits an error response as a response to the request and ends the processing. In step S1303, if the authentication server inquiry unit 403 determines that the request is made by an authenticated user (the access token included in the request is valid) (YES in step S1303), the request reception server 121 transmits the print document list acquisition request and the authenticated user information to the print document management server 123.

In step S1304, the tenant identification unit 502 of the print document management server 123 searches the tenant list 801 in FIG. 8 by using the tenant ID included in the user information to identify the individual tenant information 802 of the user who makes the request.

In step S1305, the print document management unit 501 of the print document management server 123 searches the transfer document list included in the individual tenant information 802. In step S1306, the print document management unit 501 determines whether there is individual transfer document information 805 in which the user name included in the user information is specified as the transfer destination user name. If the print document management unit 501 determines that there is no individual transfer document information 805 in which the user name included in the user information is specified as the transfer destination user name (NO in step S1306), the processing proceeds to step S1313. If the print document management unit 501 determines that there is individual transfer document information 805 in which the user name included in the user information is specified as the transfer destination user name (YES in step S1306), the processing proceeds to step S1307.

In step S1307, the user identification unit 503 of the print document management server 123 searches the owner list included in the individual tenant information 802 to identify the individual owner information 803 of the user who makes the print document list acquisition request. In step S1309, the print document management unit 501 searches whether the transfer source user name in the individual transfer document information 805 detected in step S1306 is included in the transfer reception permission list included in the identified individual owner information 803. If the print document management unit 501 determines that the individual transfer reception permission information 806 including the user name corresponding to the transfer source user name in the individual transfer document information 805 detected in step S1306 exists in the transfer reception permission list (YES in step S1310), the processing proceeds to step S1311. Otherwise (NO in step S1310), the processing proceeds to step S1313.

In step S1311, the print document management unit 501 generates the individual print document information 804 related to the transfer document and adds the generated individual print document information 804 to the print document list included in the individual owner information 803. In step 1312, the print document management unit 501 deletes the individual transfer document information 805 detected in step S1306 from the transfer document list. The processing proceeds to step 1313. In step S1313, the print document management unit 501 obtains the print document list 902, and the response transmission unit 404 of the request reception server 121 transmits data of the obtained print document list as a response to the request.

In the example illustrated in FIG. 1, each server of the print document management system is configured of a single unit, but may be configured of a plurality of servers having the same role, with a cluster configuration. Alternatively, it is to be understood that one or more servers may be consolidated into a single server.

A print document history list for each user may be provided on the print document management server so that the transfer source user can record the history of transfer of print documents. In this case, in the sequence 913 illustrated in FIG. 9, the transfer history of the print document is added to the print document history list, as well as the transfer document is added to the transfer document list.

As described above, according to the present exemplary embodiment of the present invention, a print document can be transferred among users (the owner of the print document can be changed) in a print service on the Internet where the print document list is completely independent for each user and the access right thereof is managed.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and function.

This application claims the benefit of Japanese Patent Application No. 2012-236803 filed Oct. 26, 2012, which is hereby incorporated by reference herein in its entirety.

What is claimed is:

1. A print document management apparatus for managing a print document list for each user, the print document management apparatus comprising:
a transfer document determination unit configured to determine whether a request for uploading print document data specifies a transfer destination user to whom the print document data is to be transferred;
a first addition unit configured to add individual transfer document information to a transfer document list which can be accessed by a plurality of users if the transfer document determination unit determines that the transfer destination user is specified, wherein the individual transfer document information includes information for identifying the print document data, information about a transfer source user, and information about the transfer destination user;
a second addition unit configured to search, when a request for acquiring the print document list is received, the transfer document list for the individual transfer document information in which a user who makes the request for acquiring the print document list is specified as the transfer destination user, and to add print document data identified based on the searched-for individual transfer document information to a print document list of the user who makes the request for acquiring the print document list; and
a transmission unit configured to transmit the print document list of the user who makes the request for acquiring the print document list.

2. The print document management apparatus according to claim 1, wherein, if the transfer document determination unit determines that the transfer destination user is not specified, the first addition unit adds the information for identifying the print document data to the print document list of the user who makes the upload request.

3. The print document management apparatus according to claim 1, wherein, if there is individual transfer document information in which the user who makes the request for acquiring the print document list is specified as the transfer destination user, and if the second addition unit determines that the transfer source user in the searched-for individual transfer document information is registered in a transfer reception permission list, the second addition unit adds the print document data associated with the searched-for individual transfer document information to the print document list of the user who makes the request for acquiring the print document list.

4. The print document management apparatus according to claim 3, wherein, if the second addition unit determines that the transfer source user in the searched-for individual transfer document information is not registered in the transfer reception permission list, the second addition unit does not add the print document data associated with the searched-for individual transfer document information to the print document list of the user who makes the request for acquiring the print document list.

5. The print document management apparatus according to claim 1, wherein, if there is no individual transfer document information in which the user who makes the request for acquiring the print document list is specified as the transfer destination user, the second addition unit does not add print document data to the print document list of the user who makes the request for acquiring the print document list and the transmission unit transmits a print document list based on the print document list of the user to which print document data is not added by the second addition unit.

6. The print document management apparatus according to claim 1, further comprising an inquiry unit configured to inquire of an authentication server whether an access token included in the request for uploading the print document data is valid,
wherein the user who makes the request for uploading the print document data is identified based on a result of inquiry by the inquiry unit.

7. The print document management apparatus according to claim 1, further comprising a second inquiry unit configured to inquire of an authentication server whether an access token included in the request for acquiring the print document list is valid,
wherein the user who makes the request for acquiring the print document list is identified based on a result of inquiry by the second inquiry unit.

8. The print document management apparatus according to claim 1, wherein, if the transfer document determination unit determines that the transfer destination user is specified, the first addition unit adds individual transfer document information, including information for identifying the print document data, information about a transfer source user, and information about the transfer destination user, to a transfer document list, which can be accessed by a plurality of users, and adds the transfer history of the print document data to a history list.

9. The print document management apparatus according to claim 1, further comprising a generation unit configured to convert the print document specified by a print request into print data which can be interpreted by a printer specified as a print destination, store the print data, and to transmit the print data to the printer according to the print request from the printer if the request for printing the print document is received.

10. A computer-readable storage medium storing a program that causes a processor to manage a print document list for each user:
a transfer document determination unit configured to determine whether a request for uploading print document data specifies a transfer destination user to whom the print document data is to be transferred;
a first addition unit configured to add individual transfer document information to a transfer document list which can be accessed by a plurality of users if the transfer document determination unit determines that the transfer destination user is specified, wherein the individual transfer document information includes information for identifying the print document data, information about a transfer source user, and information about the transfer destination user;
a second addition unit configured to search, when a request for acquiring the print document list is received, the transfer document list for the individual transfer document information in which a user who makes the request for acquiring the print document list is specified as the transfer destination user, and to add print document data identified based on the searched-for individual transfer document information to a print document list of the user who makes the request for acquiring the print document list; and
a transmission unit configured to transmit the print document list of the user who makes the request for acquiring the print document list.

11. A print document management method executed by an apparatus which manages a print document list for each user, the print document management method comprising:
determining whether a request for uploading print document data specifies a transfer destination user to whom the print document data is to be transferred;
adding individual transfer document information to a transfer document list which can be accessed by a plurality of users if it is determined that the transfer destination user is specified, wherein the individual transfer document information includes information for identifying the print document data, information about a transfer source user, and information about the transfer destination user;
acquiring the print document list when a request is received, searching the transfer document list for the individual transfer document information in which a user who makes the request for acquiring the print document list is specified as the transfer destination user, and adding print document data identified based on the searched-for individual transfer document information to a print document list of the user who makes the request for acquiring the print document list; and
transmitting the print document list of the user who makes the request for acquiring the print document list.
